(19) United States
(12) Patent Application Publication
(10) Pub. No.: US 2009/0073968 A1
(43) Pub. Date: Mar. 19, 2009

(54) Device with modified round robin arbitration scheme and method for transferring data

(75) Inventors: Robert H. Bishop, Suwanee, GA (US); Angus David MacAdam, Suwanee, GA (US)

Correspondence Address: Roeder & Broder LLP, 5560 Chelsea Avenue, La Jolla, CA, 92037, US

(73) Assignee: Integrated Device Technology, Inc.

(21) Appl. No.: 11/901,420

(22) Filed: Sep. 17, 2007

(51) Int. Cl. H04L 12/50

(52) U.S. Cl. 370/386

(57) ABSTRACT

A device (212) that transfers data includes a destination (216), a first data source (216), a second data source (216), a connector (220), and a control system (214). The first data source (216) can have first data to send to the destination (216). The second data source (216) can have second data to send to the destination (216). The connector (220) electrically connects the data sources (216) to the destination (216). The device control system (214) is electrically connected to the sources (216) and the destination (216). The device control system (214) utilizes an arbitration progression that sequentially grants access to the connector (220) to only the data sources (216) that have data to send to the destination (216). The device control system (214) can evaluate a first data rate of the first data and a second data rate of the second data, and can grant access to the data sources (216) that have data to send to the destination (216). Further, the device control system (214) can utilize digital hysteresis to control the granting of access to the data sources (216) that have data to send to the destination (216). This can enhance the efficiency of the device (212) with minimal, if any, increase in size or complexity.

### BACKGROUND

In a system, it is often necessary to share a resource. In its simplest form, round robin arbitration is a standard method of selecting among multiple items that are competing for the same shared resource. For example, FIG. 1 is a simplified illustration of a portion of a prior art switch 1P for an integrated circuit. In this example, the switch 1P includes a switch control system (not shown) that uses a round robin arbitration scheme 2P to offer sequential access for a predetermined interval to a plurality of input ports (labeled 0, 1, 2, 3, and N) to potentially send data from these input ports to a common destination port. In this example, the switch control system offers access to the destination port from source port 0 for the predetermined interval, and then proceeds to the next source ports in order. FIG. 1 also illustrates that data 0, 1, 2, 3, 4 . . . N has been sequentially received by the destination port. Once all N source ports have been offered access, the arbitration begins again with source port 0 offered access to the destination port.

This arbitration scheme fairly and efficiently distributes access to the destination port provided that each data source port constantly has data ready to send to the destination port.

### SUMMARY

The present invention is directed toward a device that transfers data, the device includes a destination, a first data source, a second data source, a connector, and a device control system. The first data source can have first data to send to the destination. The second data source can have second data to send to the destination. The connector electrically connects the data sources to the destination. The device control system is electrically connected to the sources and the destination. The device control system utilizes an arbitration progression that sequentially offers access to the destination to only the data sources that have data to send to the destination. This can enhance the efficiency of the device with minimal, if any, increase in size or complexity.

In one embodiment, the device is a data switch, the first data source is a first A port, the second data source is a second A port, and the destination can include a first B port and a second B port.

Additionally, the device can include a third data source and a fourth data source. The third data source can have third data to send to the destination and the fourth data source can have fourth data to send to the destination. In this embodiment, the arbitration progression again sequentially offers access to the destination to only the data sources that have data to send to the destination.

In one embodiment, the device control system evaluates a first data rate of the first data and a second data rate of the second data, and grants access to the data sources that have data to send to the destination. Further, the device control system utilizes digital hysteresis to grant access to the data sources that have data to send to the destination. In one embodiment, if one of the data source goes silent for longer than the time between data words, the device control system removes that data source from the arbitration progression. Additionally, the removed data source is added to the arbitration progression when the data source has data to send.

The present invention is also directed to a method for transferring a data from a plurality of source ports to one or more destinations.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified illustration of a prior art switch;

FIG. 2 is a simplified illustration of one embodiment of a packet based switch having features of the present invention and a portion of an integrated circuit;

FIG. 3A is a illustration of a portion of the switch of FIG. 2 illustrating the transfer of data;

FIG. 3B is a simplified illustration of the transfer of the data;

FIG. 4A is a simplified illustration of a portion of the switch of FIG. 2 illustrating another transfer of data; and

FIG. 4B is a simplified illustration of the transfer of the data;

FIG. 5 is a flow chart that illustrates one, non-exclusive example of a hysteresis algorithm that can be used by the switch of FIG. 2.

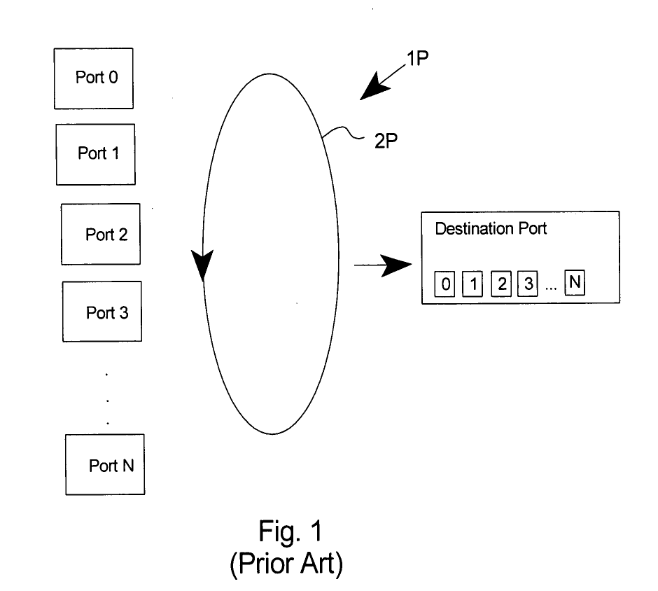

### DESCRIPTION

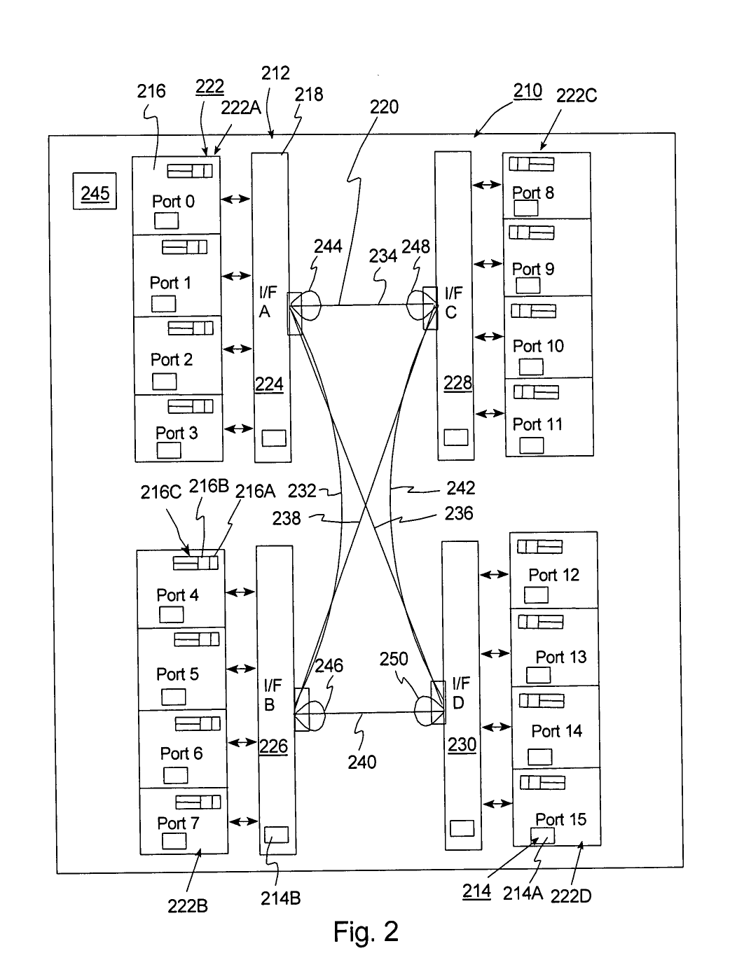

FIG. 2 is a simplified illustration of one, non-exclusive embodiment of a portion of an integrated circuit 210, and a data switch 212 (e.g. a device) having features of the present invention that is electrically connected to the integrated circuit 210. With this design, the data switch 212 is used to transfer data through the integrated circuit 210. As an overview, in certain embodiments, the switch 212 includes a switch control system 214 that uses a unique arbitration progression that fairly and efficiently transfers data within the switch 212. In certain embodiments, the arbitration progression utilizes a modified round-robin scheme that removes (e.g. does not offer access to) data sources that are silent (have no available data). This can enhance the efficiency of the data switch 212 with minimal, if any, increase in size or complexity to the arbitration progression.

In one embodiment, the switch 212 also includes a plurality of ports 216, a plurality of interfaces 218, and a plurality of electrical connectors 220. In this embodiment, the switch 212 takes advantage of the parallel nature of the mesh architecture while reducing the number of electrical connectors 220 to reduce the overall size of the switch 212. More specifically, in this embodiment, instead of using dedicated electrical connectors (not shown) from every port 216 to every other port 216, the present invention groups a number of ports 216 together into separate port groups 222. These port groups 222 are then connected with electrical connectors 220 in a mesh architecture, with every port group 222 being connected to every other port group 222.

In one embodiment, the switch 212 is supported by the integrated circuit 210.

Each of the ports 216 provides a connection point for connecting to the integrated circuit 210. The number of ports 216 in the switch 212 can be changed to achieve the design requirements of the switch 212. In FIG. 2, the switch 212 includes sixteen ports 216 (labeled ports 0-15). Alternatively, the switch 212 can be designed with more than sixteen or fewer than sixteen ports 216. In FIG. 2, the ports 216 have been organized into four port groups 222, namely, an A port group 222A (including ports 0-3), a B port group 222B (including ports 4-7), a C port group 222C (including port 8-11), and a D port group 222D (including ports 12-15). Further, in FIG. 2, each of the port groups 222A-222D includes four ports 216. Alternatively, depending upon the design requirements of the switch 212, the ports 216 can be divided into more than four or fewer than four port groups 222A-222D, and/or one or more of the port groups 222A-222D can include more than four or fewer than four ports 216. It should be noted that any of these ports can be referred to as a first port, a second port, a third port, or a fourth port. Further, any of these ports can also be referred to as a data source or a destination. It should be noted that a port to which a data packet is directed shall be referred to as a “destination port” and a port that is sending a data packet shall be referred to as a “source port”.

In one embodiment, each of the ports 216 includes (i) an output buffer 216A that provides temporary storage of data that is leaving the respective port 216; and (ii) an input buffer 216B that provides temporary storage of data arriving at the respective port. In one embodiment, there is a separate memory for each priority data packet. Alternatively, portions of the same memory can be used for each priority data packet.

Further, each port 216 can include a packet tracker 216C that tracks a certain number of packets. For example, the packet tracker 216C can track four packets per priority. Alternatively, the packet tracker 216C can be designed to track more than four or fewer than four packets per priority.

The number of interfaces 218 used in the switch 212 can be varied according to the number of port groups 222A-222D. In certain embodiments, each port group 222A-222D includes an interface 218. Thus, the number of interfaces 218 is equal to the number of port groups 222A-222D. Alternatively, the switch 212 can be designed with more than four or fewer than four interfaces 218.

In FIG. 2, the interfaces 218 can be referred to as the A interface 224, the B interface 226, the C interface 228, and the D interface 230. In this embodiment, (i) the A interface 224 is part of the A port group 222A, and is directly electrically connected to and services ports 0-3; (ii) the B interface 226 is part of the B port group 222B, and is directly electrically connected to and services ports 4-7; (iii) the C interface 228 is part of the C port group 222C, and is directly electrically connected to and services ports 8-11; and (iv) the D interface 230 is part of the D port group 222D, and is directly electrically connected to and services ports 12-15. In one embodiment, each of the interfaces 224-230 includes logic that controls the transfer of data between the ports 216.

The number of connectors 220 used in the switch 212 can be varied according to the number of interfaces 218. In FIG. 2, the switch 212 includes ten connectors 220 that can be named an AB connector 232, an AC connector 234, an AD connector 236, a BC connector 238, a BD connector 240, a CD connector 242, an M connector 244, a BB connector 246, a CC connector 248, and a DD connector 250. In this embodiment, (i) the AB connector 232 directly connects the A interface 224 to the B interface 226; (ii) the AC connector 234 directly connects the A interface 224 to the C interface 228; (iii) the AD connector 236 directly connects the A interface 224 to the D interface 230; (iv) the BC connector 238 directly connects the B interface 226 to the C interface 228; (v) the BD connector 240 directly connects the B interface 226 to the D interface 230; (vi) the CD connector 242 directly connects the C interface 228 to the D interface 230, (vii) the AA connector 244 loops back and directly connects the A interface 224 to the A interface 224, (viii) the BB connector 246 loops back and directly connects the B interface 226 to the B interface 226, (ix) the CC connector 248 loops back and directly connects the C interface 228 to the C interface 228, and (x) the DD connector 250 loops back and directly connects the D interface 230 to the D interface 230.

In one embodiment, the connectors 220 between interfaces 218 have enough bandwidth to support the aggregate bandwidth of the ports 216 in the port group 222. For example, the bandwidth of the connectors 220 can be time-sliced so that all ports 216 in each port group 222 have a dedicated portion of the connector 220 bandwidth, each portion of which is large enough to support the maximum bandwidth that the port 216 can provide. In this way, the parallel data transfer advantage in bandwidth that is achieved in the traditional mesh architecture is maintained while the number of connectors 220 required can be reduced to make this hybrid architecture more size-efficient.

As one non-exclusive example, each connector 220 can have a bandwidth of approximately 10 gigabits/second. In this example, if all of the ports 216 of a particular interface 218 have data to transmit, each of the ports 216 would get 2.5 gigabits/second for a 10 gigabit/second system. Alternatively, (i) if only three ports 216 have data to transmit, each of the ports 216 would get 3.3 gigabits/second for a 10 gigabit/second system, (ii) if only two ports 216 have data to transmit, each of the ports 216 would get 5 gigabits/second for a 10 gigabit/second system, or (iii) if only one port 216 has data to transmit, this port 216 would get 10 gigabits/second for a 10 gigabit/second system.

The switch control system 214 controls the transfer of data in the switch 212. In one embodiment, the switch control system 214 uses a unique arbitration scheme that fairly and efficiently transfers data in the switch 212. More specifically, the switch control system 214 utilizes a modified round-robin arbitration progression that grants access to ports 216 that have data to send for a predetermined interval, and removes ports 216 that are no longer providing data. With this design, the control system 214 improves the utilization of the shared resource by granting access to only the ports 216 that have data to transfer. Thus, the goal of the control system 214 is to remove data sources that are silent (have no available data) from the round robin arbitration progression.

In certain embodiments, the control system 214 uses a predictive arbitration with pipelined decision-making, among others to remove silent data sources. In one embodiment, the switch 210 includes one or more configuration registers 245 (only one is illustrated in FIG. 2) that samples the data into one or more of the data sources to determine the data flow rate for the one or more data sources. For example, the one or more configuration registers 245 can provide a first data flow rate for the first data source, a second data flow rate for the second data source, a third data flow rate for the third data source, and a N data flow rate for the N data source.

With information regarding the data rate of data coming in to the data sources, the control system 214 can make intelligent decisions on removing and adding data sources from the round robin progression. In one embodiment, this knowledge is used to implement digital hysteresis on the removal of a data source from the arbitration. For example, if a data source is silent (has no data) for a preselected hysteresis time, then the source is removed from the arbitration progression. In alternative, non-exclusive embodiments, the preselected hysteresis time can be the time between one or more data words, a single clock period, multiple clock periods, or on a packet basis (allowing an entire packet to be granted access). This hysteresis time could be adjustable either by an internal state machine or user intervention. Whenever the source has data again it is put back into the progression immediately. With this design, because of the hysteresis, the data source is removed only when the data source is silent for a time at least as long as the hysteresis time. This simplistic scheme improves the overall efficiency of the shared resource without any complicated overhead. Further, with this design, the data sources are only removed when silent for a sufficient time. This reduces the overhead to the switch caused by immediately removing a data source if the data flow rate is just slow. The benefits and operation of the arbitration progression are described in more detail below.

In one embodiment, the switch control system 214 is a distributed, decentralized control system with each port 216 including a separate port control system 214A. In this embodiment, each port control system 214A can independently make decisions regarding its port 216, in parallel with the other port control systems 214A. Additionally, each of the interfaces 218 can also include an interface control system 214B that controls the flow of data to and from that interface 218. In this example, each of the control systems 214A, 214B is merely a place where control and logic can occur.

Alternatively, for example, the control of data can occur in just the ports 216 with the separate port control systems 214A, or just the interfaces 218 with the separate interface control systems 214B. Still alternatively, the switch control system 214 can include a single, centralized control system that controls the operation of the switch 212.

In one embodiment, the control system 214 uses a switching algorithm in which all data packets stored in the buffer 216B of each port 216 of a given priority are read out sequentially without waiting to see if a particular packet is accepted or rejected at the intended destination port. Stated in another fashion, each data packet in the buffer 216B of the port 216 of a given priority is sent sequentially without waiting for acknowledgements or aborts. In this embodiment, the data packets in each port 216 are read out sequentially with the highest priority data packets granted transmission before the lower priority data packets. For example, data packets with priority 1 in the port will be transmitted before data packets with priority 0 in the port. In this example, if the port only has two data packets with priority 1 and three data packets with priority 0, the two priority 1 data packets will be sequentially sent and then the three priority 0 data packets will be sequentially sent without waiting to see if a particular packet is accepted or rejected at the intended destination port.

In this design, the acceptance or rejection of a particular data packet is determined later when the source port receives either an acknowledgment or abort signal from the intended destination port for each packet that had been read out. This architecture is a simple, space-efficient solution to head-of-line blocking for packets within the input buffer of a particular priority. This type of system can provide a significant performance increase in randomized traffic as it allows packets to be transmitted when otherwise those packets could be blocked by a packet at the front of the queue that is waiting for a congestion at its intended destination port to be resolved.

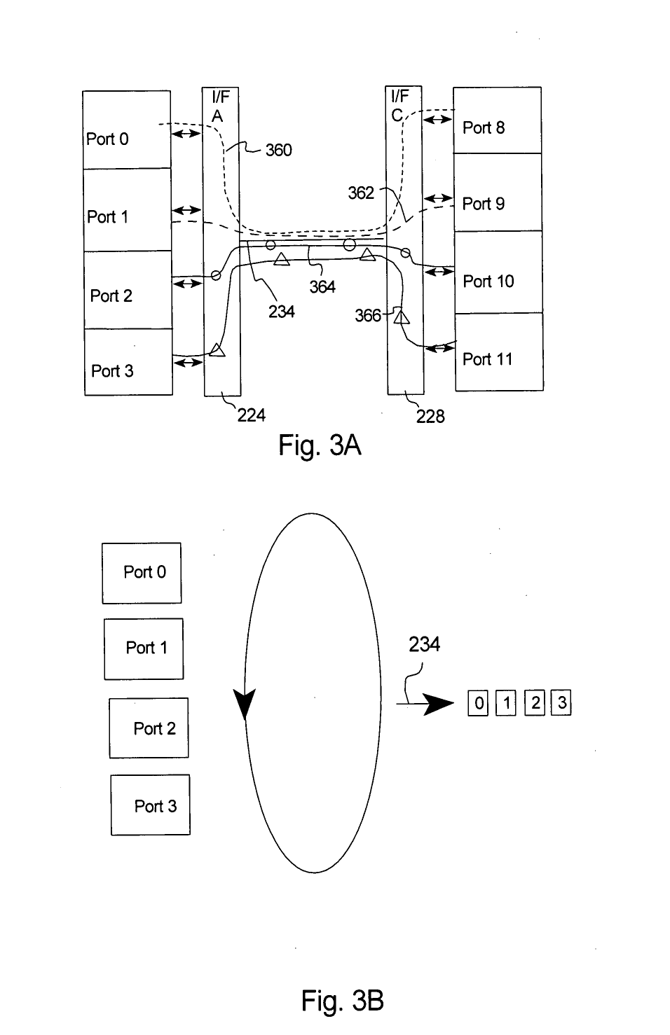

FIG. 3A is a simplified, non-exclusive illustration of how data can be transferred from a plurality of data sources (e.g. ports 0-3 in this example) to one or more destinations (e.g. ports 8-11 in this example). In this embodiment, (i) data 0 (illustrated with short dashed lines) 360 is being transferred from the port 0 to port 8; (ii) data 1 (illustrated with long dashed lines) 362 is being transferred from port 1 to the port 9; (iii) data 2 (illustrated with line with circles) 364 is being transferred from port 2 to port 10; and (iv) data 3 (illustrated with line with triangles) 366 is being transferred from port 3 to port 11. For clarity, only the A ports (ports 0-3), the C ports (ports 8-11), the A interface 224, the AC connector 234, the C interface 228 are illustrated in FIG. 3A. In this example, the data 360-366 starts at the respective source port, and is sequentially transferred to the A interface 224, the AC connector 234, the C interface 228, and then to the respective destination port.

It should be noted that a response (not shown) is sent from each destination port to its corresponding source port. The response can be in the form of an acknowledgement if the data packet was successfully transferred to the respective destination port, or an abort if the data packet was not successfully transferred to the respective destination port. An abort can occur if the destination port has no ability to receive the data packet due to output buffer being filled, or some other reason.

In this example, the AC connector 234 is a shared resource that is shared by source ports 0-3 trying to send data to destination ports 8-11. Further, in this example, each of the source ports 0-3 has data 360-366 to send to the destination ports 8-11.

As described above, the control system 214 (illustrated in FIG. 2) uses a modified round robin arbitration progression to grant sequential access for the predetermined interval to the source ports that have data to send. In this embodiment, because ports 0-3 have data to send, the arbitration progression grants sequential access for the predetermined interval to ports 0-3 to send data via AC connector 234 to destination ports 8-11.

Referring to FIG. 3B, in this example, the arbitration progression grants access to the AC connector 234 from source port 0 for the predetermined interval, and then proceeds to port 1 for the predetermined interval, and then proceeds to port 2 for the predetermined interval, and then proceeds to port 3 for the predetermined interval. FIG. 3B also illustrates that data 0, 1, 2, 3 has been sequentially transferred by the AC connector 234. Once all the source ports have been granted access, the arbitration begins again with source port 0.

In this example, if the AC connector 234 has a bandwidth of approximately 10 gigabits/second, ports 0-3 would get 2.5 gigabits/second each for transmitting the data over the AC connector 234.

The length of the predetermined interval can be varied to achieve the performance requirements of the switch. In alternative, non-exclusive embodiments, the predetermined interval can be on a word basis, a single clock period, multiple clock periods, or on a packet basis (allowing an entire packet to be granted access).

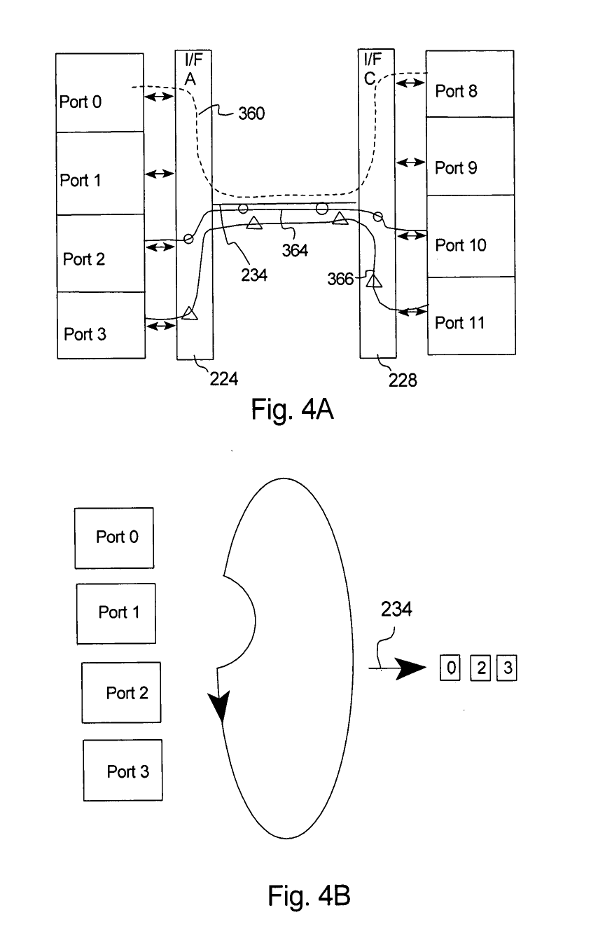

FIG. 4A is another simplified, non-exclusive illustration of how data can be transferred from a plurality of data sources (e.g. ports 0, 2, 3 in this example) to one or more destinations (e.g. ports 8, 10, 11 in this example). In this embodiment, (i) data 0 (illustrated with short dashed lines) 360 is being transferred from the port 0 to port 8; (ii) data 2 (illustrated with line with circles) 364 is being transferred from port 2 to port 10; and (ii) data 3 (illustrated with line with triangles) 366 is being transferred from port 3 to the port 11. It should be noted that in this example, port 1 does not currently have data to send. For clarity, only the A ports (ports 0-3), the C ports (ports 8-11), the A interface 224, the AC connector 234, the C interface 228 are illustrated in FIG. 4A. In this example, the data 360, 364, 366 starts at the respective source port, and is sequentially transferred to the A interface 224, the AC connector 234, the C interface 228, and then to the respective destination port.

In this example, the AC connector 234 is the resource that is shared by source ports 0, 2, 3 trying to send data to destination ports 8, 10, 11. Further, in this example, only three of the source ports 0, 2, 3 have data 360, 364, 366 to send to the destination ports 8, 10, 11.

As described above, the control system 214 (illustrated in FIG. 2) uses a modified round robin arbitration progression to grant sequential access for the predetermined interval to source ports that have data to send. In this embodiment, because only ports 0, 2, 3 have data to send, the arbitration progression grants sequential access for the predetermined interval to ports 0, 2, 3 to send data via AC connector 234 to destination ports 8, 10, 11. Referring to FIG. 4B, in this example, the arbitration progression grants access to the AC connector 234 from source port 0 for the predetermined interval, and then proceeds to port 2 for the predetermined interval, and then proceeds to port 3 for the predetermined interval. FIG. 4B also illustrates that data 0, 2, 3 has been sequentially transferred by the AC connector 234. Once all the source ports with data have been granted access, the arbitration begins again with source port 0.

In this example, if the AC connector 234 has a bandwidth of approximately 10 gigabits/second, ports 0, 2, 3 would get 3.3 gigabits/second for transmitting the data over the AC connector 234. As a result thereof, the control system 214 improves the utilization of the shared resource and the efficiency of the switch by granting access to only the ports that have data to transfer. This arbitration progression fairly and efficiently distributes access to the destination provided that each data source constantly has data ready to send to the destination. Further, the arbitration progression is relatively simple and has a cost effective implementation.

It should be noted that if only two ports have data to transmit, each of the ports would get 5 gigabits/second for a 10 gigabit/second system, or if only one port has data to transmit, this port would get 10 gigabits/second for a 10 gigabit/second system.

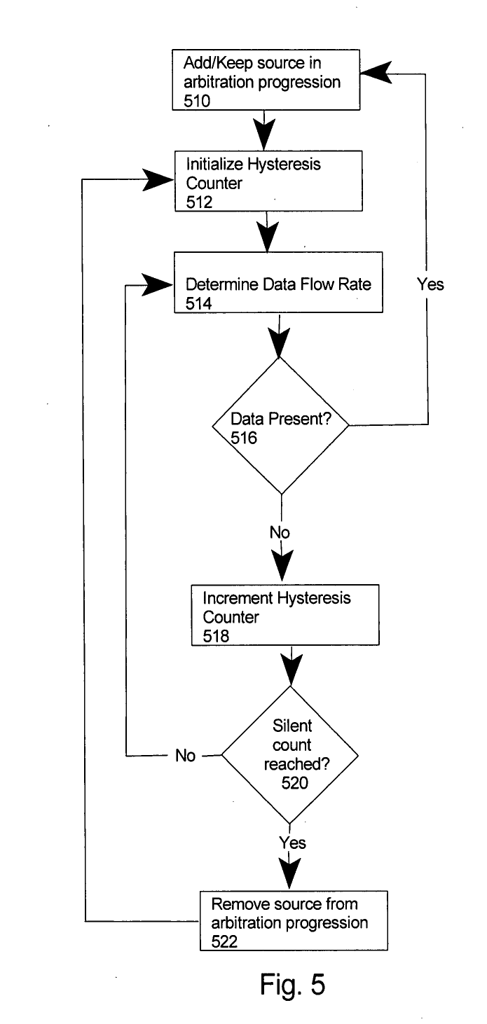

FIG. 5 is a flow chart that illustrates one non-exclusive example of the hysteresis algorithm. In this embodiment, at step 510, the control system adds/keeps the port in the arbitration progression. Next, the hysteresis counter is initialized 512. Subsequently, the configuration register is sampled to determine the data flow rate 514. The control system then determines if there is data present at each individual port 516. If yes, that port is kept in the progression. If no, the hysteresis counter is incremented 518. Next, the control system determines if a silent count is reached 520. If no, the flow is directed back to block 514. If yes, the source is removed from the arbitration progression at block 522 and flow is directed back to block 512.

While the particular invention as herein shown and disclosed in detail are fully capable of obtaining the objectives and providing the advantages herein before stated, it is to be understood that they are merely illustrative of one or more embodiments and that no limitations are intended to the details of construction or design herein shown other than as described in the appended claims.

What is claimed is:

1. A device that transfers data, the device comprising:
a destination;
a first data source of possible first data to send to the destination;
a second data source of possible second data to send to the destination;
a connector that electrically connects the data sources to the destination; and
a control system that is electrically connected to the sources and the destination, the control system utilizing an arbitration progression that sequentially grants access to the destination to only the data sources that have data to send to the destination.

2. The device of claim 1 further comprising a third data source of possible third data to send to the destination, the third data source being electrically connected to the destination with the connector.

3. The device of claim 2 further comprising a fourth data source of possible fourth data to send to the destination, the fourth data source being electrically connected to the destination with the connector.

4. The device of claim 1 wherein the first data source is a first A port and the second data source is a second A port.

5. The device of claim 1 wherein the destination includes a first B port and a second B port.

6. The device of claim 1 wherein the device control system evaluates a first data rate of the first data and a second data rate of the second data to grant access to only the data sources that have data to send to the destination.

7. The device of claim 6 wherein the device control system utilizes digital hysteresis to grant access to only the data sources that have data to send to the destination.

8. The device of claim 6 wherein if one of the data sources goes silent for as long as a preselected hysteresis time, the control system removes that data source from the arbitration progression.

9. The device of claim 8 wherein the removed data source is added immediately to the arbitration progression when the data source has data to send.

10. The device of claim 8 wherein the preselected hysteresis time is a time between data words.

11. A switch that transfers data, the switch comprising:
a destination;
a first data port of possible first data to send to the destination;
a second data port of possible second data to send to the destination;
a third data port of possible data to send to the destination;
a connector that electrically connects the data ports to the destination; and
a control system that is electrically connected to the ports and the destination, the control system evaluates a first data rate of the first data, a second data rate of the second data, and a third data rate of the third data, and the control system uses an arbitration progression that sequentially grants access to the destination access to only the data ports that have data to send to the destination.

12. The switch of claim 11 wherein the device control system utilizes digital hysteresis to grant access to only the data ports that have data to send to the destination.

13. The switch of claim 12 wherein if one of the data ports goes silent for as long as a preselected hysteresis time, the control system removes that data port from the arbitration progression.

14. The switch of claim 13 wherein the removed data port is added immediately to the arbitration progression when the data port has data to send.

15. The switch of claim 13 wherein the preselected hysteresis time is a time between data words.

16. The device of claim 11 wherein the destination includes a first B port and a second B port.

17. A method for transferring data to a destination, the method comprising the steps of:
providing a first data port of possible first data to send to the destination;
providing a second data port of possible second data to send to the destination;
providing a third data port of possible data to send to the destination;
electrically connecting the data ports to the destination;
evaluating a first data rate of the first data, a second data rate of the second data, and a third data rate of the third data with a control system that is electrically connected to the data ports; and
sequentially granting access to the destination to only the data ports that have data to send to the destination with the control system.

18. The method of claim 17 wherein the step of sequentially granting includes the step of utilizing digital hysteresis to grant access to only the data ports that have data to send to the destination.

19. The method of claim 18 wherein the step of utilizing digital hysteresis includes if one of the data ports goes silent for as long as a preselected hysteresis time, the control system removes that data port from the arbitration progression.

20. The method of claim 19 wherein the preselected hysteresis time is a time between data words.
